(19) United States
(12) Patent Application Publication
(10) Pub. No.: US 2010/0217471 A1
(43) Pub. Date: Aug. 26, 2010

(54) TIRE PRESSURE DEVIATION DETECTION FOR A VEHICLE TIRE

(76) Inventors: Anders Stenman, Linkoping (SE); Urban Forssell, Linkoping (SE); Peter Lindskog, Linkoping (SE); Tony Gustafsson, Askim (SE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/531,687

(22) PCT Filed: Mar. 16, 2007
(86) PCT No.: PCT/EP07/02370

§ 371 Date: Mar. 11, 2010

(51) Int. Cl. B60C 23/00; B60C 23/20

(52) U.S. Cl. 701/29

(57) ABSTRACT

A method, system and computer program product for detecting a tire pressure deviation in a tire of a vehicle by determining tire pressure indicating data indicative of a tire pressure condition of the tire and determining tire pressure deviation data indicative of a tire pressure deviation in the tire.

### FIELD OF THE INVENTION

The present invention is directed to an indirect tire pressure monitoring method, system and computer program product for detecting a tire pressure deviation in a tire of a vehicle by determining tire pressure data indicative of a tire pressure condition of the tire and determining tire pressure deviation data indicative of a tire pressure deviation condition in the tire.

### BACKGROUND OF THE INVENTION

Monitoring of tire pressure can be assumed to become a standard functionality in vehicles, at least in cars and trucks, not only due to governmental and legal regulations but also in view of a general demand for enhanced vehicle safety.

Generally, tire pressure monitoring can be accomplished directly and indirectly.

In direct tire pressure monitoring, a current pressure in a vehicle tire is directly measured, e.g. by means of a sensor arranged inside the tire. An example of direct tire pressure monitoring is described, e.g., in U.S. Pat. No. 7,111,507 B2.

Indirect tire pressure monitoring uses information, which—in contrast to directly obtained pressure values—is somehow related to the tire pressure. Commonly, such information may be provided by further control and/or detection devices of vehicles, such as ECUs (electronic control unit), antilock braking systems, dynamic stability systems, anti-spin systems and traction control systems, in form of digital and/or analog data and/or signals. The information may include the rotational speed or angular velocity of the tire or its wheel, respectively, which information is then used as basis to calculate or estimate a value representing tire pressure. An example of indirect tire pressure monitoring is described, e.g., in DE 103 60 723 A1.

Particularly indirect tire pressure monitoring requires complex computation and calculation to derive tire pressure from pressure-related information. Moreover, the connection between pressure-related information and tire pressure is prone to external influences, such as current driving situations and road conditions. A further example of such influences is temperature conditions.

For example, in the direct tire pressure monitoring according to U.S. Pat. No. 7,111,507 B2, a tire pressure sensor arranged in a tire senses the current tire pressure on the basis of which a tire pressure value is determined. Temperature variation could lead to undesired variation in the tire pressure value. To take into account temperature influences, a temperature compensated gas temperature inside the tire is determined on the basis of temperature information. The temperature compensated gas temperature in the tire is in turn used to determine a temperature compensated tire pressure value.

In the indirect tire pressure monitoring according to DE 103 60 723 A1, tire pressure values, which have been derived from pressure-related information, are temperature compensated on the basis of ambient or tire temperature.

In both cases, temperature compensation may lead to incorrect evidence on actual tire pressure.

### OBJECT OF THE INVENTION

The object of present invention is to provide means improving indirect tire pressure monitoring to overcome the drawbacks of prior art temperature compensation and, particularly, such that resulting tire pressure indicating information at least essentially corresponds to an actually prevailing tire pressure.

### SUMMARY OF THE INVENTION

To solve the above object, the present invention provides a method, a system and a computer program product as defined in the independent claims.

According to a first aspect the present invention provides an indirect tire pressure monitoring method of detecting tire pressure deviation in tire(s) of a vehicle, comprising the steps of:
determining tire pressure indicating data indicative of a tire pressure condition of at least one tire of a vehicle;
determining tire pressure deviation data indicative of a tire pressure deviation condition in the at least one tire on the basis of the tire pressure indicating data;
obtaining at least one vehicle data provided by a controlling and/or monitoring device of the vehicle;
determining temperature compensation data on the basis of the at least one vehicle data; and
temperature compensating on the basis of the temperature compensation data such that temperature compensated tire pressure deviation data is achieved.

According to another aspect, the present invention provides an indirect tire pressure monitoring system for detecting tire pressure deviation in tire(s) of a vehicle, comprising:
means for determining tire pressure indicating data indicative of a tire pressure condition of at least one tire of a vehicle;
means for determining tire pressure deviation data indicative of a tire pressure deviation condition in the at least one tire on the basis of the tire pressure indicating data;
means for obtaining at least one vehicle data provided by a controlling and/or monitoring device of the vehicle;
means for determining temperature compensation data on the basis of the at least one vehicle data; and
means for temperature compensating on the basis of the temperature compensation data such that temperature compensated tire pressure deviation data is achieved.

According to a further aspect, the present invention provides a computer program product for an indirect tire pressure monitoring for detecting tire pressure deviation in tire(s) of a vehicle, the computer program product comprising program code for carrying out, when executed on a processing system, the steps of:
determining tire pressure indicating data indicative of a tire pressure condition of at least one tire of a vehicle;
determining tire pressure deviation data indicative of a tire pressure deviation condition in the at least one tire on the basis of the tire pressure indicating data;
obtaining at least one vehicle data provided by a controlling and/or monitoring device of the vehicle;
determining temperature compensation data on the basis of the at least one vehicle data; and
temperature compensating on the basis of the temperature compensation data such that temperature compensated tire pressure deviation data is achieved.

Further aspects, features and advantages of the present invention will become apparent from the below description, the accompanying drawings and the appended claims.

### SHORT DESCRIPTION OF THE DRAWINGS

Embodiments of the invention will now be described, by way of example and with reference to the accompanying drawings, in which:

FIG. 1 schematically illustrates a principle system arrangement according to an embodiment of the present invention; and

FIG. 2 schematically illustrates a unit for determining tire pressure deviation data as well as temperature compensation data determination and temperature compensation according to an embodiment of the present invention.

### DESCRIPTION OF PREFERRED EMBODIMENTS

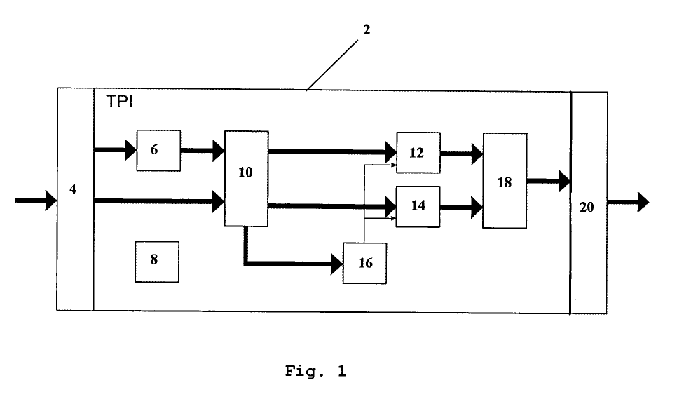

FIG. 1 schematically illustrates a principle system arrangement according to the present invention, particularly in form of a tire pressure deviation (TPD) warning system 2 using indirect tire pressure monitoring.

The present invention is provided for use in any kind of vehicle having at least one wheel equipped with at least one tire. The term “vehicle” as used herein comprises any type of vehicle, such as cars, bikes, trucks, trailers, and the like, where information on the basis of which indirect tire pressure monitoring is possible.

A “pressure deviation” in a tire may be detected if the tire pressure actually determined for the tire differs from a normal/predefined/desired tire pressure and/or differs from the pressure of one or more other tires by a predetermined threshold value.

However, before continuing with descriptions of the drawings, some further observations to further aspects of the present invention are given. More detailed observation to the method related aspects of the present invention also apply to corresponding system related aspects and computer program related aspects of the present invention even if not explicitly noted.

The method of the present invention may include that
the step of determining tire pressure deviation data comprises a step of determining individual tire pressure deviation data for each of the at least one tire; and
the step of temperature compensating is carried out with respect to each of the individual tire pressure deviation data to achieve temperature compensated tire pressure deviation data separately for each of the at least one tire.

Such embodiments are, e.g., applicable where a vehicle and/or the used tire pressure monitoring means provide and compute, respectively, information on absolute pressure of individual tires. An example of such cases is the below described embodiment using wheel spectrum analysis.

The method of the present invention may include that
the step of determining tire pressure deviation data comprises a step of determining relative tire pressure deviation data for at least two tires of the vehicle; and
the step of temperature compensating is carried out with respect to each of the at least one relative tire pressure deviation data to achieve temperature compensated tire pressure deviation data for the at least two tires.

Such embodiments are, e.g., applicable where a vehicle and/or the used tire pressure monitoring means provide and compute, respectively, information on relative pressure of tires. It is noted that information on relative tire pressure may be based on information on absolute tire pressure as above. An example of such cases is the below described embodiment using wheel radius analysis.

Further, it is contemplated to generate (individual) tire pressure deviation data on the basis of correlation analysis such as, e.g. disclosed in WO 2005/005993 Al, the entire content of which being incorporated in the present disclosure by reference.

The method of the present invention may include that
the step of determining temperature compensation data comprises at least one step of determining specific temperature compensation data for at least one predefined temperature condition; and
the step of temperature compensating comprises a step of specific temperature compensating on the basis of the specific temperature compensation data.

Such embodiments allow, e.g., to take into account that the at least one vehicle data, a respective signal providing vehicle device, the step of determining pressure indicating data, the step of determining tire pressure deviation data, the step of determining temperature compensation data, the step of temperature compensating and/or means used to carry out such steps may have temperature dependent characteristics, which may require temperature dependent temperature compensation. An example of this is the below described embodiment, wherein vehicle data, vehicle data providing units, determination of tire pressure indicating data and/or determination of tire pressure deviation data may have temperature dependent performance(s).

Here, it is possible that the step of temperature compensating comprises a step of specific temperature compensating the tire pressure deviation data on the basis of at least one of a weighting function, a multiplicative function, a non-symmetric function and a temperature-related adaptive rate.

The method of the present invention may include that the at least one vehicle data includes at least one of
vehicle data indicative of ambient temperature;
vehicle data indicative of a temperature of an engine of the vehicle;
vehicle data indicative of an engine torque of an engine of the vehicle;
vehicle data indicative of a torque acting on the at least one tire;
vehicle data indicative of a engine speed of an engine of the vehicle;
vehicle data indicative of a yaw rate of the vehicle;
vehicle data indicative of a speed of the vehicle;
vehicle data indicative of at least one of a lateral acceleration and a longitudinal acceleration of the vehicle;
vehicle data indicative of a steering wheel angle of a steering wheel of the vehicle;
vehicle data indicative of a driving condition of the vehicle, particularly a braking condition;
vehicle data indicative that a gear shift of the vehicle is in progress;
vehicle data indicative that a braking system of the vehicle is operating (e.g. a brake active flag);
vehicle data indicative of brake pressure; and
vehicle data indicative that at least one active control device of the vehicle is active.

The method of the present invention may include that the step of determining the temperature compensation data comprises at least one of:
determine an internal tire temperature for the at least one tire;
determining a wheel slip effective for the at least one tire;
determining a gear ratio effective for the at least one tire;
determining a traction force acting on the at least one tire;
determining a road condition affecting the at least one pressure data;
determining whether a snow chain is arranged on the at least one tire; and
determining a curve driving condition of the vehicle.

The method of the present invention may include that the step of temperature compensating comprises a step of temperature compensating the at least one vehicle data based on the temperature compensation data to compensate temperature influence on the at least one vehicle data.

In such embodiments, at least those temperature impacts that affect the at least one vehicle data itself may be directly temperature compensated.

The method of the present invention may include that the step of temperature compensating the at least one vehicle data comprises a step of temperature compensating at least one device of the vehicle providing a corresponding one of the at least one vehicle data.

These embodiments allow to compensate at least those temperature impacts that affect vehicle data device(s), whereby the at least one vehicle data may be indirectly temperature compensated.

Here, it is further possible that the step of temperature compensating the at least one vehicle data providing device comprises a step of temperature compensating at least one of:
means comprising at least one temperature sensor;
means comprising at least one yaw rate sensor;
means comprising at least one torque sensor;
means comprising at least one speed sensor; and
means comprising at least one acceleration sensor.

A sensor may include one ore more separate sensor units, wherein a sensor unit may be hardware-based or software-based or a combination thereof.

The method of the present invention may include that the step of temperature compensating comprises a step of temperature compensating the tire pressure indicating data on the basis of the temperature compensation data.

Such embodiments, e.g., may include to temperature compensate wheel/tire radii and/or spectra derived from tire pressure indicating data as described further below.

Here, it is possible that the step of temperature compensating the tire pressure indicating data is performed by using rules obtained from physical knowledge on temperature influence on pressure data indicative of a pressure condition of a tire and/or empirical knowledge on temperature influence on pressure data indicative of a pressure condition of a tire.

Such cases allow, e.g., to take into account effects resulting from a tire subjected internal and/or external temperature variations (e.g. “. . . what happens when the tire gets warmer/colder . . . ”) and/or to employ statistical analysis of dependencies between means (e.g. sensors, signals, units) having temperature related properties and different temperature conditions.

The method of the present invention may include that the step of temperature compensating comprises a step of temperature compensating the tire pressure deviation data itself on the basis of the temperature compensation data.

Such embodiments may only rely on temperature of the tire pressure deviation data itself. Such embodiments may additionally include at least one of above described temperature compensation, possibly resulting in an enhanced, more reliable and/or correct temperature compensation and, thus, monitoring of tire pressure.

The method of the present invention may further comprise a step of comparing the tire pressure deviation data with deviation threshold data to determine whether the tire pressure deviation condition exceeds at least one predefined deviation-related threshold.

Embodiments of this kind provide, e.g., measure(s) to ascertain whether the tire pressure deviation data indicate a tire pressure deviation being to high, unacceptable or the like.

Here, the method of the present invention may further comprise a step of correcting the deviation threshold data on the basis of the temperature compensation data.

Such embodiments consider that also the deviation threshold data might have a temperature dependency that could be (also) temperature compensated. Further, it might be beneficial to modify the deviation threshold data in dependence of the actual temperature condition(s) such that in certain (e.g. excessive) temperature condition(s) reliable statements on tire pressure and/or tire pressure deviation are (still) possible.

The method of the present invention may further comprise a step of controlling at least one of
the step of determining the tire pressure indicating data;
the step of determining the tire pressure deviation data;
the step of obtaining the at least one vehicle data; and
the step of determining the temperature compensation data; on the basis of the temperature compensation data such that a temperature compensation is achieved.

The method of the present invention may further comprise a step of pausing at least one of the steps of the step of determining tire pressure indicating data, the step of determining tire pressure deviation data, the step of obtaining at least one vehicle data, the step of determining temperature compensation data and the step of temperature compensating in the case the temperature compensation data indicate a temperature condition outside a predefined range and resuming the at least one of said steps in the case the temperature compensation data indicate a temperature condition back in the predefined range.

Such embodiments allow, e.g., to stop carrying out the method of the present invention in cases of temperature condition(s) that hinder a reliable determination of tire pressure deviation data and/or statements on tire pressure and/or tire pressure deviation based thereon.

In the system of the present invention it is possible that
the means for determining tire pressure deviation data is adapted to determine individual tire pressure deviation data for each of the at least one tire; and
the means for temperature compensating is adapted to separately temperature compensate with respect to each of the individual tire pressure deviation data on the basis of the temperature compensation data to achieve temperature compensated tire pressure deviation data for each of the at least one tire.

In the system of the present invention it is possible that
the means for determining tire pressure deviation data is adapted to determine relative tire pressure deviation data for at least two tires of the vehicle; and
the means for temperature compensating is adapted to temperature compensate with respect to each relative tire pressure deviation data on the basis of the temperature compensation data to achieve temperature compensated tire pressure deviation data for the at least two tires.

In the system of the present invention it is possible that
the means for temperature compensation data is adapted to determine specific temperature compensation data for at least one predefined specific temperature condition; and
the means for temperature compensating is adapted to temperature compensate the tire pressure deviation data on the basis of the specific temperature compensation data.

Here, it is possible that the means for temperature compensation data is adapted to temperature compensate the tire pressure deviation data on the basis of at least one of a weighting function, a multiplicative function, a non-symmetric function and a temperature-related adaptive rate.

The system of the present invention may further include at least one input for obtaining, as the least one vehicle data, at least one of
vehicle data indicative of ambient temperature;
vehicle data indicative of a temperature of an engine of the vehicle;
vehicle data indicative of an engine torque of an engine of the vehicle;
vehicle data indicative of a torque acting on the at least one tire;
vehicle data indicative of an engine speed of an engine of the vehicle;
vehicle data indicative of a yaw rate of the vehicle;
vehicle data indicative of a speed of the vehicle;
vehicle data indicative of at least one of a lateral acceleration and a longitudinal acceleration of the vehicle;
vehicle data indicative of a steering wheel angle of a steering wheel of the vehicle;
vehicle data indicative of a driving condition of the vehicle, particularly a braking condition;
vehicle data indicative that a gear shift of the vehicle is in progress;
vehicle data indicative that a braking system of the vehicle is operating (e.g. a brake active flag);
vehicle data indicative of brake pressure; and
vehicle data indicative that at least one active control device of the vehicle is active.

In the system of the present invention it is possible that the means for determining the temperature compensation data is adapted to at least one of:
determine an internal tire temperature for the at least one tire;
determine a wheel slip effective for the at least one tire;
determine a gear ratio effective for the at least one tire;
determine a traction force acting on the at least one tire;
determine a road condition affecting the at least one pressure data;
determine whether a snow chain is arranged on the at least one tire; and
determine a curve driving condition of the vehicle.

In the system of the present invention it is possible that the means for temperature compensating is adapted to temperature compensate the at least one vehicle data based on the temperature compensation data to compensate temperature influence on the at least one vehicle data.

Here, it is possible that the means for temperature compensating the at least one vehicle data is adapted to temperature compensate at least one device of the vehicle providing a corresponding one of the at least one vehicle data.

Here, it is further possible that the means for temperature compensating the at least one vehicle data providing device is adapted to temperature compensate at least one of:
means comprising at least one temperature sensor;
means comprising at least one yaw rate sensor;
means comprising at least one torque sensor;
means comprising at least one speed sensor; and
means comprising at least one acceleration sensor.

A sensor may include one ore more separate sensor units, wherein a sensor unit may be hardware-based or software-based or a combination thereof.

In the system of the present invention it is possible that the means for temperature compensating is adapted to temperature compensate the tire pressure indicating data on the basis of the temperature compensation data.

Here it is possible that the means for correcting the at least one pressure data is adapted to correct the at least one pressure data by using rules obtained from physical knowledge on temperature influence on pressure data indicative of a pressure condition of a tire and/or empirical knowledge on temperature influence on pressure data indicative of a pressure condition of a tire.

In the system of the present invention it is possible that the means for temperature compensating is adapted to temperature compensate the tire pressure deviation data itself on the basis of the temperature compensation data.

The system of the present invention may further comprise means for comparing the tire pressure deviation data with deviation threshold data and for determining based on the comparison result whether the tire pressure deviation condition exceeds at least one predefined deviation-related threshold.

Here, the system of the present invention may further comprise means for correcting the deviation threshold data on the basis of the temperature compensation data.

The system of the present invention may further comprise correction control means for at least partially controlling at least one of the
the means for determining the tire pressure indicating data;
the means for determining the tire pressure deviation data;
the means for obtaining the at least one vehicle data; and
the means for determining the temperature compensation data; on the basis of the temperature compensation data in order to achieve temperature compensation with respect thereto.

The system of the present invention may further comprise means for disabling at least one of the means for determining tire pressure indicating data, the means for determining tire pressure deviation data, the means for obtaining at least one vehicle data, the means for determining temperature compensation data and the means for temperature compensating in the case the temperature compensation data indicate a temperature condition outside a predefined range and enabling the at least one of said means in the case the temperature compensation data indicate a temperature condition back in the predefined range.

The computer program product of the present invention may further comprise program code for carrying out, when executed on a processing system, the steps of at least one of the above-mentioned possible embodiments of the method of the present invention.

The computer program product of the present invention may be stored on a computer-readable storage medium or in a computer-readable storage device.

Now, referring to the drawings again, FIG. 1 schematically illustrates a principle system arrangement according to the present invention, particularly in form of a tire pressure deviation (TPD) warning system 2.

The TPD warning system 2 may for example be a hardware and/or software component, which is integrated in an electronic control unit (e.g. ECU) of a vehicle. The system 2 obtains so-called vehicle data by means of an interface 4, which may be—in the case of an at least partially software based implementation—an application program interface (API). The vehicle data may include vehicle signals from the vehicle CAN bus e.g. describing the vehicle condition. The vehicle data may (further) include measuring data, information, signals and the like directly obtained and/or indirectly derived from vehicle's sensors, such as rotational speed sensors (as existent in the vehicle's ABS), which indicate angular velocities of rotating wheels and tires, respectively.

In particular, the vehicle data may be indicative of ambient temperature, temperature of an engine of the vehicle, wheel/tire angular velocity, wheel/tire rotational speed, engine torque of an engine of the vehicle, torque acting on the at least one tire, engine speed of an engine of the vehicle, yaw rate of the vehicle, speed of the vehicle, lateral and/or longitudinal acceleration of the vehicle, steering wheel angle of a steering wheel of the vehicle, of a driving condition of the vehicle, particularly a braking condition, gear shift of the vehicle being in progress and an active control device of the vehicle being actively operating.

Any of such data may be used by units for determining tire pressure indicating data, which units are described below. However, any of such data may also indicate—directly or indirectly—temperature(s) that might influence tire pressure. Ambient and engine temperatures may apparently alter tire pressure via a variation of a tire temperature (e.g. internal temperature of the tire, gas temperature inside the tire, temperature of the tire's material). Effects resulting from the vehicle speed may also influence tire pressure because, e.g., higher velocities will lead to higher tire temperature and, thus, to higher tire pressure. Also, current driving situations, such as driving on curvy roads, stop-and-go, driving conditions resulting in driver-independent control of the vehicle (e.g. active antilock braking, dynamic stability, anti-spin and/or traction control measures), may affect tire pressure due to, e.g., increased flexing work of the tire.

To provide such vehicle data, an ECU and/or sensors of the vehicle may be used. For example, temperature sensor(s), yaw rate sensor(s), torque sensor(s), speed sensor(s), accelerator sensor(s), and/or sensors indicating accelerator pedal, clutch pedal and/or braking pedal position(s) my be employed to acquire vehicle data and/or to perform measurements on the basis of which vehicle data may be derived.

In some embodiments, at least one temperature sensor may be arranged (e.g. coupled) to the system 2 and/or an ECU or any other place in/on the vehicle suitable to measure ambient temperature. Also, sensors to directly measure internal tire temperature may be used.

Additional or alternative temperature sensor(s) may by arranged to measure gas temperature in the intake manifold in the engine, brake disc temperature, wheel rim temperature and/or temperature resulting from relative wind. Temperature information may be—in addition or as alternative—obtained, as set forth above, on the basis of know relation(s) between driving situations and internal tire temperature (e.g. heat build-up, for example, on wheel rims during braking and acceleration).

The vehicle data may directly provided to units of system 2 and/or may be stored in a memory unit 6 for later use.

A diagnosis control unit 8 performs internal system and input signal checks and sets system status and error codes. If a severe error occurs, this unit can disable the system 2.

Obtained vehicle data may be input to a pre-processing unit 10, which may process (e.g. filters) vehicle data, for example, to remove disturbances and offsets, and may pre-compute vehicle data such that they can be used by other system parts.

According to the described embodiments, interface 4, memory unit 6 and pre-processing unit 10 may be considered as implementation of the step of and/or means for obtaining at least one vehicle data.

Signals output by pre-processing unit 10 are input to a wheel radius analysis (WRA) unit 12 and/or a wheel spectrum analysis (WSA) unit 14. According to the embodiments described here, WRA unit 12 and a WSA unit 14 represent an implementation of the step of determining tire pressure indicating data and/or as means for determining tire pressure indicating data.

To this end, WRA unit 12 and a WSA unit 14 will be provided vehicle data (unprocessed and/or processed by pre-processing unit 10) at least indicating wheel/tire angular velocity and/or wheel/tire rotational speed.

Further vehicle signals may be related to wheel/tire angular velocity “energy”, yaw rate, yaw rate from wheel/tire velocity, engine torque, braking in progress, reverse driving in progress, active control in progress, vehicle speed, longitudinal acceleration, lateral acceleration, wheel slip, normalized traction force, gear shift in progress, data quality indicators (dynamic driving, slip variance, etc.), ambient temperature and vehicle status.

In some embodiments, WRA unit 12 and WSA unit 14 may be further provided data indicating, e.g., special driving conditions (e.g. driving with snow chains, on rough roads, on oval track and in a roundabout etc.). Such data may be generated by a dynamic state detector 16 based on vehicle data from interface 4, memory 6 and/or pre-processing unit 10. Thus, data from dynamic state detector 16 are here also referred to as vehicle data as they are derived there from.

Wheel radius analysis as executed in the WRA unit 12 are based on the fact that the wheel speed of a wheel depends on the respective wheel radius: the wheel speed increases with decreasing wheel radius. Changes in the wheel radius contain information about changes in the tire pressure of the corresponding wheels, but may also reflect, e.g., vehicle load changes and surface changes or react on driving forces (acceleration, braking, forces in curves etc.).

According to the described embodiments, WRA unit 12 may be considered as implementation of the step of and/or means for determining relative tire pressure deviation data for at least two tires. As described further below, temperature compensation may be then carried out to achieve temperature compensated tire pressure deviation data for the at least two tires.

Based on the wheel angular velocity signals, WSA unit 14 detects changes in the spectral properties of each of the four wheel angular velocity signals. The tire pressure has significant influence on the characteristics of the spectrum of the angular velocity signal; however, further conditions (e.g. driving situation, road surface and temperature) may also have an impact on the angular velocity signal spectrum and may be therefore considered.

In further embodiments, WSA unit 14 may use DFT-based approach(es) and/or method(s) to determine wheel/tire spectrum.

In any case, WSA unit 14 may detect changes in tire pressure for each wheel individually, for example by calculating a parametric model of the wheel/tire velocity spectrum and using the parameters of this model to calculate a spectral shape factor that condenses the different pressure dependent features of the spectrum into one single scalar quantity.

According to the described embodiments, WSA unit 14 may be considered as implementation of the step of and/or means for determining individual tire pressure deviation data for the at least one tire. As described further below, temperature compensation may be then carried out to achieve temperature compensated tire pressure deviation data for each of the at least one tire.

In further embodiments, individual tire pressure deviation data may be provided by correlation analyses as disclosed in WO 2005/005933 A1.

In such cases and assuming a vehicle having at least one pair of a front and a rear wheel being spaced by a wheel spacing, front wheel/tire speed and rear wheel/tire speed information, which indicates time dependent behavior of the front wheel/tire speed and rear wheel/tire speed, is determined. Then, the front wheel/tire speed and rear wheel/tire speed information is correlated in order to determine a specific correlation feature indicative of the time delay between the front wheel and rear wheel speed signals. On the basis of the correlation feature and the wheel spacing, a velocity of the vehicle may be determined.

Tire pressure indicating data may provided by WRA unit 12 only or by WSA unit 14 only or by both WRA unit 12 and WSA unit 14.

A combination/compensation unit 18 obtains data from WRA unit 12 and/or WSA unit 14 and from interface 4, memory unit 6 and/or pre-processing unit 10. According to the described embodiments, combination/compensation unit 18 can be considered as implementation of the step of determining tire pressure deviation data and/or means for determining tire pressure deviation data.

More specifically, data provided to combination/compensation unit 18 include tire pressure indicating data of at least one of WRA unit 12 and WSA unit 14. Such data will be used to determine tire pressure deviation data indicative of tire pressure deviation condition(s) for the vehicle tire. To this end, combination/compensation unit 18 may also use data indicating, e.g., special driving conditions (e.g. driving with snow chains, on rough roads, on oval track and in a roundabout etc.) provided by dynamic state detector 16 and/or further vehicle data.

In general, combination/compensation unit 18 determines, based on input data, tire pressure deviation condition(s) for each tire separately or for at least two tires together. In embodiments not illustrated, combination/compensation unit 18 determines whether tire pressure indicating data indicate a deviation from a preset, desired and/or required tire pressure. To this end, combination/compensation unit 18 may additionally take into account further input data, such as data representing a current driving situation, since such data may influence a decision whether an inappropriate tire pressure deviation exists.

Such determination(s) may use threshold comparison(s). Then, an inappropriate tire pressure deviation may be ascertained in the case tire pressure indicating data violate an upper and/or lower threshold (e.g. maximally and minimally, respectively, allowable tire pressure).

If an inappropriate tire pressure deviation condition is detected, combination/compensation unit 18 may generate warning data, enable a warning signal and the like to inform about the inappropriate tire pressure deviation condition.

Such warning information may be coupled, via an interface 20, to an ECU of the vehicle, which in turn may initiate measures suitable in view of the current tire pressure deviation condition (e.g. active control measures for reducing speed, reducing acceleration and/or brake forces and/or torques for the respective tire, etc.; informing a driver of the vehicle by visual information, warning lights, speech and/or sound output). Interface 20 may be integrally embodied with interface 4 or may provided separately.

In addition or as alternative, warning information may be forwarded to a warning unit (not shown) that performs functions as set forth above for an ECU and/or communicates with an ECU to inform about the inappropriate tire pressure deviation condition. In the case a warning unit is comprised by system 2, communication with external devices may be accomplished via interface 20. Warning information may be also stored for later analysis.

Alternatively, a bi-directional counter may be used, which bidirectional counter is started if tire pressure deviation exceeds a threshold and starts to count up. If tire pressure deviation falls below the threshold, the bi-directional counter counts in the opposite direction.

In such embodiments and also in any case where one or more counters are used for generating warning information, a counter may be temperature compensated in order to take into account that temperature (variation) may influence, e.g., threshold used for starting the counted, tire pressure, tire pressure deviation.

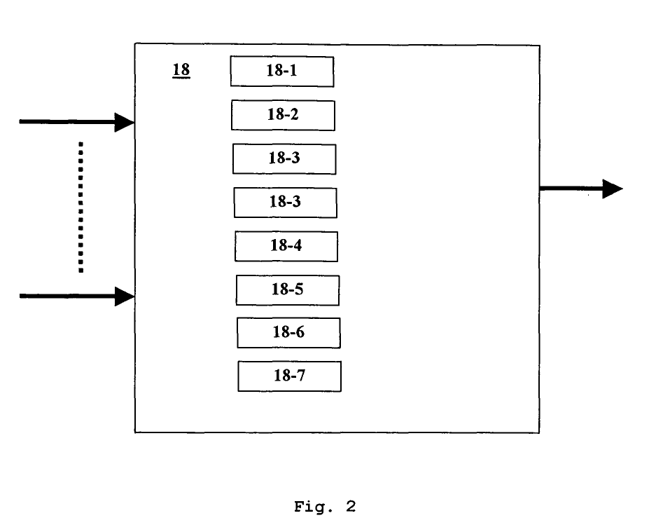

According to the embodiment shown in FIG. 2, combination/compensation unit 18 is adapted to perform a more complex procedure to determine tire pressure deviation conditions. As illustrated, combination/compensation unit 18 comprises several sub-units 18-1, . . . , 18-n, which will be also referred to as detectors. Detectors 18-1, . . . , 18-n are used to detect specific tire pressure deviation conditions.

For illustration of such embodiments, it is assumed that detectors 18-1, . . . , 18-n comprise a puncture detector 18-1, a diffusion detector 18-2, a flat tire detector 18-3, an asymmetric detector 18-4, a special detector 18-5, a leakage-during-calibration detector 18-6 and a high-sensitivity detector 18-7.

Each of the detectors 18-1, . . . , 18-n may be associated to all tires or may comprise sub-detectors (not shown) each associated to a specific tire or each detector type may be provided several times respectively associated to a specific tire. Here, it is assumed that each of the detectors 18-1, . . . , 18-n operates for all tires.

Puncture detector 18-1 operates on a short time scale, typically in minutes, in order to detect rapid pressure loss(es) in a tire.

Diffusion detector 18-2 operates on a long time scale, typically hours, to detect slow pressure loss in a tire.

Flat tire detector 18-3 operates on a very short time scale in order to detect rapid and large pressure drops in tire.

Asymmetric detector 18-4 complements the puncture and diffusion detectors to enhance the detection performance in asymmetric tire pressure scenarios. An example of such a situation is a pressure drop in one tire of, e.g., 15% and in another tire of, e.g., 30%. Asymmetric detector 18-4 may be also important for improving the detection performance in special load cases.

Special detector 18-5 complements the puncture and diffusion detectors to enhance the detection performance in situations with no or low torque variations.

Leakage-during-calibration detector 18-6 detects a continuous pressure drop in a tire during system calibration.

High sensitivity detector 18-7 operates on a short time scale to detect repeated tire problems in a tire.

Detectors 18-1, . . . , 18-n respectively employ, inter alia, thresholds to determine prevailing of a tire pressure deviation condition for which a respective one of the detectors 18-1, . . . , 18-n is dedicated.

For example, puncture detector 18-1 uses, inter alia, a threshold to detect rapid pressure loss(es) in tire(s), diffusion detector 18-2 uses, inter alia, a threshold to detect slow pressure loss(es) in tire(s), flat tire detector 18-3 uses, inter alia, a threshold to detect rapid and large pressure drop(s) in tire(s), asymmetric detector 18-4 uses, inter alia, a threshold to detect asymmetric tire pressure scenarios, special detector 18-5 uses, inter alia, a threshold to detect tire pressure deviation conditions with no or low torque variation(s), leakage-during-calibration detector 18-6 uses, inter alia, a threshold to detect continuous pressure drop(s) in tire(s) during calibration of system 2 and high sensitivity detector 18-7 uses, inter alia, a threshold to detect repeated tire pressure problem(s) in tire(s).

In dependence, for example, how detectors 18-1, . . . , 18-n are provided (e.g.—as set forth above—a specific detector for all tires; comprising sub-detectors; a detector type provided several times), the number of thresholds per individual detector may vary. In some embodiments, each detector may use more than one threshold. However, for sake of illustration and not for limitation, it is assumed here that each detector uses a single threshold. In any case, such threshold(s) represent a possible implementation of deviation threshold data.

According to the described embodiments, combination/compensation unit 18 also provides for temperature compensation and can be therefore considered to implement the step of determining temperature compensation data and the step of temperature compensating and/or to provide means for determining tire pressure deviation data and means for temperature compensating. In further embodiments, temperature compensation data determination and/or temperature compensation may be accomplished by one or more separate units.

For temperature compensation, combination/compensation unit 18 may receive any of the above-mentioned vehicle data and/or information derived there from on the basis of which temperature compensation data can be determined. Temperature compensation data include any information that may be used to compensation temperature influence(s) directly and/or indirectly affecting tire pressure deviation data.

Temperature compensation data may be based on “absolute” temperature information, e.g. information indicating current temperature(s) actually effective, and/or “relative” temperature information, e.g. information indicating difference(s) between current temperature(s) actually effective and respectively associated reference temperature. A possible reference temperature may be a temperature effective during calibration of system 2.

Tire pressure deviation data are based on, inter alia, vehicle data. Temperature variation may affect vehicle data and, thus, tire pressure deviation data. To compensate such temperature influence(s), the temperature compensation data may indicate that one or more vehicle data and/or on or more devices providing vehicle data are to be temperature compensated.

In order to temperature compensate vehicle data itself it is contemplated to apply, e.g., temperature related correction factors, functions and the like. In the case of devices providing vehicle data this may be also accomplished, e.g., by applying temperature related correction factors, functions and the like. For example, in the case of sensor, temperature compensation may be achieved by using a model of the sensor's temperature dependent measuring behavior (e.g. offset drift).

Tire pressure deviation data are based on, inter alia, tire pressure indicating data. Temperature variation may affect tire pressure indicating data not only because tire pressure indicating data are based on vehicle data, which may subjected temperature variation, but also because temperature variation may influence generation of tire pressure indicating data. Further, temperature effects on vehicle data and temperature effects on measures to obtain tire pressure indicating data may have different impacts. Nevertheless, temperature influencing tire pressure indicating data may also affect tire pressure deviation data.

To compensate such temperature influence(s), the temperature compensation data may indicate that one or more tire pressure indicating data are to be temperature compensated. This may be accomplished, e.g., by employing mathematical models, knowledge—particularly physical knowledge—and empirical knowledge to temperature compensate tire pressure indicating data itself and/or models, parameters and the like used to derive tire pressure indicating data. For example, physical knowledge on relation of tire pressure and internal tire temperature and/or statistical analysis defining dependencies of underlying model parameter(s) and different temperature conditions may be employed.

Tire pressure indicating data itself may be also temperature dependent due to, e.g., temperature effect of means used for generation of tire pressure indicating data. To compensate such temperature influence(s), the temperature compensation data may indicate that tire pressure indicating data itself and/or respective data generation means are to be temperature compensated.

In order to temperature compensate tire pressure indicating s data itself is it contemplated to, e.g., apply temperature related correction factors, functions and the like. In the case of means for determining tire pressure indicating data this may be also accomplished, e.g., by applying temperature related correction factors, functions and the like.

In the case thresholds, e.g. for one or more of the detectors described above, are used, temperature compensation may be carried out, e.g., by adapting threshold(s) such that different temperature conditions may be accommodated. Threshold adaptation may be preformed, e.g., according to temperature-related step function(s), continuous function(s), discontinuous function(s), adaptive rate(s), symmetric function(s), asymmetric function(s) and weighting function(s).

The temperature compensation may be based either be on a current temperature or on a difference between a current and a predefined temperature (e.g. temperature during calibration).

Further in the case of detectors comparable to those described above, it may be possible that one or more specific detectors are less suitable under certain temperature condition(s). Then, output of such a detector may be modified on the basis of a multiplicative function, which is, e.g., 1 for a temperature condition in that the detector is properly working and which has a values higher and/or lower than, e.g., 1 for temperature condition(s) in which the detector is not properly working. In the case of more than one temperature condition in that the detector is not properly working, for each temperature condition a multiplicative function may have different magnitudes. Rather than a multiplicative function, a continuous function may be used, whereby different temperature conditions may be mapped more precisely. A possible continuous function may include or be an exponential term or function. It is noted that such functions may be (also) used for temperature compensation previously described.

In embodiments described in greater detail here, modification of such detector(s) may be based on a multiplicative function, h(T_{current}), wherein T_{current} indicates a current temperature. Assuming a threshold temperature, below which (a) to be modified detector(s) is properly working, function h(T_{current}) could be defined to be 1 for cases of |T_{current}|<Tₗᵢₘᵢₜ and to be 0 for to cases of |T_{current}|<Tₗᵢₘᵢₜ. Then, output I of a to be modified detector can be defined as I_{modified}=I_{default}×h(T_{current}), wherein I_{default} indicates the unmodified detector output (e.g. signal output at a detector output port) and I_{modified} indicates a modified detector output (e.g. a signal actually used in tire pressure monitoring as information from the to be modified detector).

In further embodiments, a function h(ΔT) may be employed, wherein ΔT indicates a difference between a current temperature and a reference temperature (e.g. temperature during calibration). Such a function may be beneficial to emphasize data coming from similar (temperature) conditions as during a condition for which the reference temperature is defined (e.g. condition prevailing for calibration). In such cases, function h(ΔT) may be defined as 0≦h(ΔT)≦1 and h(0)=1, wherein h(ΔT) can decrease with increasing |ΔT| (e.g. h(ΔT)=exp(−γ|ΔT|) with γ being a positive constant) or h(ΔT) can increase with increasing |ΔT| (e.g. h(ΔT)=|ΔT|^{γ} with γ being a positive constant greater than 1). To consider that tire pressure usually increases with increasing temperature and vice versa, a non-symmetric function h(ΔT) may be used, for example h(ΔT)=1−ΕΔT for ΔT≧0 and =1−βΔT for ΔT<0, where α and β are suitably chosen constants.

In some embodiment, the temperature compensation data may indicate that temperature compensation is, e.g., not feasible, not possible, not desired, unreliable etc. For example, on or more temperature conditions (e.g. temperature range, maximal temperature, minimal temperature) may be defined for which not temperature compensation should be carried out. In the case such a temperature condition is detected, temperature compensation may be interrupted or paused as long as that temperature condition is prevailing. When the temperature condition is left, temperature compensation is resumed again. To this end, the temperature compensation data may include respective information, such as, information indicating to disable temperature compensation and to enable temperature compensation, respectively. Such information may be provided to one, several or all components of system 2 in order to accordingly disable and enable its or their, respectively, operation.

1.-37. (canceled)

38. An indirect tire pressure monitoring method of detecting tire pressure deviation in tires of a vehicle, comprising:
determining tire pressure indicating data indicative of a tire pressure condition of at least one tire of a vehicle; and
determining tire pressure deviation data indicative of a tire pressure deviation condition in the at least one tire on the basis of the tire pressure indicating data;
characterized by:
obtaining at least one vehicle data provided by a controlling and/or monitoring device of the vehicle;
determining temperature compensation data on the basis of the at least one vehicle data; and
temperature compensating on the basis of the temperature compensation data such that temperature compensated tire pressure deviation data is achieved;
characterized by:
pausing at least one of the above in the case the temperature compensation data indicate a temperature condition outside a predefined range and resuming the at least one of the above in the case the temperature compensation data indicate a temperature condition back in the predefined range.

39. The method of claim 38,
wherein
determining e pressure deviation data comprises determining individual tire pressure deviation data for each of the at least one tire; and
temperature compensating comprises temperature compensating with respect to each of the individual tire pressure deviation data on the basis of the temperature compensation data such that temperature compensated tire pressure deviation data for each of the at least one tire is achieved; and/or
wherein
determining tire pressure deviation data comprises determining relative tire pressure deviation data for at least two tires of the vehicle; and
temperature compensating comprises temperature compensating with respect to each of the relative tire pressure deviation data on the basis of the temperature compensation data to achieve temperature compensated tire pressure deviation data for the at least two tires; and/or
wherein
determining temperature compensation data comprises at least one step of determining specific temperature compensation data for at least one predefined temperature condition; and
temperature compensating comprises temperature compensating the tire pressure deviation data on the basis of the specific temperature compensation data,
wherein temperature compensating preferably comprises temperature compensating the tire pressure deviation data on the basis of at least one of a weighting function, a multiplicative function, a non-symmetric function and a temperature-related adaptive rate; and/or
wherein the at least one vehicle data includes at least one of
vehicle data indicative of ambient temperature;
vehicle data indicative of a temperature of an engine of the vehicle;
vehicle data indicative of an engine torque of an engine of the vehicle;
vehicle data indicative of a torque acting on the at least one tire;
vehicle data indicative of a engine speed of an engine of the vehicle;
vehicle data indicative of a yaw rate of the vehicle;
vehicle data indicative of a speed of the vehicle;
vehicle data indicative of at least one of a lateral acceleration and a longitudinal acceleration of the vehicle;
vehicle data indicative of a steering wheel angle of a steering wheel of the vehicle;
vehicle data indicative of a driving condition of the vehicle, particularly a braking condition;
vehicle data indicative that a gear shift of the vehicle is in progress;
vehicle data indicative that a braking system of the vehicle is operating;
vehicle data indicative of brake pressure; and
vehicle data indicative that at least one active control device of the vehicle is active; and/or
wherein determining the temperature compensation data comprises at least one of:
determining an internal tire temperature for the at least one tire
determining a wheel slip effective for the at least one tire;
determining a gear ratio effective for the at least one tire;
determining a traction force acting on the at least one tire;
determining a road condition affecting the at least one pressure data;
determining whether a snow chain is arranged on the at least one tire;
determining a curve driving condition of the vehicle; and/or
wherein temperature compensating comprises temperature compensating the at least one vehicle data based on the temperature compensation data to compensate temperature influence on the at least one vehicle data, wherein temperature compensating the at least one vehicle data preferably comprises temperature compensating at least one device of the vehicle providing a corresponding one of the at least one vehicle data, wherein temperature compensating the at least one vehicle data providing device preferably comprises temperature compensating at least one of:
means comprising at least one temperature sensor;
means comprising at least one yaw rate sensor;
means comprising at least one torque sensor;
means comprising at least one speed sensor; and
means comprising at least one acceleration sensor; and/or
wherein temperature compensating comprises temperature compensating the tire pressure indicating data on the basis of the temperature compensation data, wherein temperature compensating tire pressure indicating data is preferably performed by using rules obtained from physical knowledge on temperature influence on pressure data indicative of a pressure condition of a tire and/or empirical knowledge on temperature influence on pressure data indicative of a pressure condition of a tire; and/or
wherein temperature compensating comprises temperature compensating the tire pressure deviation data itself on the basis of the temperature compensation data; and/or
further comprising comparing the tire pressure deviation data with deviation threshold data to determine whether the tire pressure deviation exceeds at least one predetermined deviation-related threshold, preferably further comprising correcting the deviation threshold data on the basis of the temperature compensation data; and/or
further comprising controlling at least one of
determining the tire pressure indicating data;
determining the tire pressure deviation data;
obtaining the at least one vehicle data; and
determining the temperature compensation data;
on the basis of the temperature compensation data such that a temperature compensation is achieved.

40. An indirect tire pressure monitoring system o detecting tire pressure deviation in tires of a vehicle, comprising:
means for determining tire pressure indicating data indicative of a tire pressure condition of at least one tire of a vehicle; and
means for determining tire pressure deviation data indicative of a tire pressure deviation condition in the at least one tire on the basis of the tire pressure indicating data;
characterized by:
means for obtaining at least one vehicle data provided by a controlling and/or monitoring device of the vehicle;
means for determining temperature compensation data on the basis of the at least one vehicle data; and
means for temperature compensating on the basis of the temperature compensation data such that temperature compensated tire pressure deviation data is achieved,
characterized by
means for disabling at least one of the above means of claim in the case the temperature compensation data indicate a temperature condition outside a predefined range and enabling the at least one of the above means in the case the temperature compensation data indicate a temperature condition falling back in the predefined range.

41. The system of claim 40,
wherein
the means for determining tire pressure deviation data is adapted to determine individual tire pressure deviation data for each of the at least one tire; and
the means for temperature compensating adapted to temperature compensate with respect to each of the individual tire pressure deviation data on the basis of the temperature compensation data to achieve temperature compensated tire pressure deviation data for each of the at least one tire; and/or
wherein
the means for determining tire pressure deviation data is adapted to determine relative tire pressure deviation data for at least two tires of the vehicle; and
the means for temperature compensating is adapted to temperature compensate with respect to each relative tire pressure deviation data on the basis of the temperature compensation data to achieve temperature compensated tire pressure deviation data for the at least two tires together; and/or
wherein
the means for determining temperature compensation data is adapted to determine specific temperature compensation data for at least one predefined temperature condition; and
the means for temperature compensating is adapted to temperature compensate the tire pressure deviation data on the basis of the specific temperature compensation data, preferably wherein the means for temperature compensating is adapted to temperature compensate the tire pressure deviation data on the basis of at least one of a weighting function, a multiplicative function, a non-symmetric function and a temperature-related adaptive rate; and/or
further including at least one input for obtaining, as the least one vehicle data, at least one of
vehicle data indicative of ambient temperature;
vehicle data indicative of a temperature of an engine of the vehicle;
vehicle data indicative of an engine torque of an engine of the vehicle;
vehicle data indicative of a torque acting on the at least one tire;
vehicle data indicative of a engine speed of an engine of the vehicle;
vehicle data indicative of a yaw rate of the vehicle;
vehicle data indicative of a speed of the vehicle;
vehicle data indicative of at least one of a lateral acceleration and a longitudinal acceleration of the vehicle;
vehicle data indicative of a steering wheel angle of a steering wheel of the vehicle;
vehicle data indicative of a driving condition of the vehicle, particularly a braking condition;
vehicle data indicative that a gear shift of the vehicle is in progress;
vehicle data indicative that a braking system of the vehicle is operating;
vehicle data indicative of brake pressure; and
vehicle data indicative that at least one active control device of the vehicle is active; and/or
wherein the means for determining the temperature compensation data is adapted to at least one of:
determine an internal tire temperature for the at least one tire;
determine a wheel slip effective for the at least one tire;
determine a gear ratio effective for the at least one tire;
determine a traction force acting on the at least one tire;
determine a road condition affecting the at least one pressure data;
determine whether a snow chain is arranged on the at least one tire; and
determine a curve driving condition of the vehicle; and/or
wherein the means for temperature compensating is adapted to temperature compensate the at least one vehicle data based on the temperature compensation data to compensate temperature influence on the at least one vehicle data, wherein the means for temperature compensating the at least one vehicle data is preferably adapted to temperature compensate at least one device of the vehicle providing a corresponding one of the at least one vehicle data, wherein the means for temperature compensating the at least one vehicle data providing device is preferably adapted to temperature compensate at least one of:
means comprising at least one temperature sensor;
means comprising at least one yaw rate sensor;
means comprising at least one torque sensor;
means comprising at least one speed sensor; and
means comprising at least one acceleration sensor; and/or
wherein the means for temperature compensating is adapted to temperature compensate the tire pressure indicating data on the basis of the temperature compensation data, wherein the means for correcting the tire pressure indicating data is preferably adapted to correct the tire pressure indicating data by using rules obtained from physical knowledge on temperature influence on pressure data indicative of a pressure condition of a tire and/or empirical knowledge on temperature influence on pressure data indicative of a pressure condition of a tire; and/or
wherein the means for temperature compensating is adapted to temperature compensate the tire pressure deviation data itself on the basis of the temperature compensation data; and/or
further comprising means for comparing the tire pressure deviation data with deviation threshold data and for determining based on the comparison result whether the tire pressure deviation condition exceeds at least one predetermined deviation-related threshold, further comprising means for correcting the deviation threshold data on the basis of the temperature compensation data; and/or
further comprising correction control means for at least partially controlling at least one of the
the means for determining the tire pressure indicating data;
the means for determining the tire pressure deviation data;
the means for obtaining the at least one vehicle data; and
the means for determining the temperature compensation data;
on the basis of the temperature compensation data in order to achieve temperature compensation with respect thereto.

42. A computer program product for an indirect tire pressure monitoring for detecting tire pressure deviation in tires of a vehicle, the computer program product comprising program code for carrying out, when executed on a processing system:
determining tire pressure indicating data indicative of a tire pressure condition of at least one of a vehicle; and
determining tire pressure deviation data indicative of a tire pressure deviation condition in the at least one tire on the basis of the tire pressure indicating data;
characterized by:
obtaining at least one vehicle data provided by a controlling and/or monitoring device of the vehicle;
determining temperature compensation data on the basis of the at least one vehicle data; and
temperature compensating on the basis of the temperature compensation data such that temperature compensated tire pressure deviation data is achieved,
characterized by
pausing at least one of the above in the case the temperature compensation data indicate a temperature condition outside a predefined range and resuming the at least one of the above in the case the temperature compensation data indicate a temperature condition back in the predefined range.

43. The computer program product of claim 42, further comprising program code for carrying out, when executed on a processing system, at least one of the alternatives of
wherein
determining tire pressure deviation data comprises determining individual tire pressure deviation data for each of the at least one tire; and
temperature compensating comprises temperature compensating with respect to each of the individual tire pressure deviation data on the basis of the temperature compensation data such that temperature compensated tire pressure deviation data for each of the at least one tire is achieved; and/or
wherein
determining tire pressure deviation data comprises determining relative tire pressure deviation data for at least two tires of the vehicle; and
temperature compensating comprises temperature compensating with respect to each of the relative tire pressure deviation data on the basis of the temperature compensation data to achieve temperature compensated tire pressure deviation data for the at least two tires; and/or
wherein
determining temperature compensation data comprises at least one step of determining specific temperature compensation data for at least one predefined temperature condition; and
temperature compensating comprises temperature compensating the tire pressure deviation data on the basis of the specific temperature compensation data,
wherein temperature compensating preferably comprises temperature compensating the tire pressure deviation data on the basis of at least one of a weighting function, a multiplicative function, a non-symmetric function and a temperature-related adaptive rate; and/or
wherein the at least one vehicle data includes at least one of
vehicle data indicative of ambient temperature;
vehicle data indicative of a temperature of an engine of the vehicle;
vehicle data indicative of an engine torque of an engine of the vehicle;
vehicle data indicative of a torque acting on the at least one tire;
vehicle data indicative of a engine speed of an engine of the vehicle;
vehicle data indicative of a yaw rate of the vehicle;
vehicle data indicative of a speed of the vehicle;
vehicle data indicative of at least one of a lateral acceleration and a longitudinal acceleration of the vehicle;
vehicle data indicative of a steering wheel angle of a steering wheel of the vehicle;
vehicle data indicative of a driving condition of the vehicle, particularly a braking condition;
vehicle data indicative that a gear shift of the vehicle is in progress;
vehicle data indicative that a braking system of the vehicle is operating;
vehicle data indicative of brake pressure; and
vehicle data indicative that at least one active control device of the vehicle is active; and/or
wherein determining the temperature compensation data comprises at least one of:
determining an internal tire temperature for the at least one tire
determining a wheel slip effective for the at least one tire;
determining a gear ratio effective for the at least one tire;
determining a traction force acting on the at least one tire;
determining a road condition affecting the at least one pressure data;
determining whether a snow chain is arranged on the at least one tire;
determining a curve driving condition of the vehicle; and/or
wherein temperature compensating comprises temperature compensating the at least one vehicle data based on the temperature compensation data to compensate temperature influence on the at least one vehicle data, wherein temperature compensating the at least one vehicle data preferably comprises temperature compensating at least one device of the vehicle providing a corresponding one of the at least one vehicle data, wherein temperature compensating the at least one vehicle data providing device preferably comprises temperature compensating at least one of:
means comprising at least one temperature sensor;
means comprising at least one yaw rate sensor;
means comprising at least one torque sensor;
means comprising at least one speed sensor; and
means comprising at least one acceleration sensor; and/or
wherein temperature compensating comprises temperature compensating the tire pressure indicating data on the basis of the temperature compensation data, wherein temperature compensating tire pressure indicating data is preferably performed by using rules obtained from physical knowledge on temperature influence on pressure data indicative of a pressure condition of a tire and/or empirical knowledge on temperature influence on pressure data indicative of a pressure condition of a tire; and/or
wherein temperature compensating comprises temperature compensating the tire pressure deviation data itself on the basis of the temperature compensation data; and/or
further comprising comparing the tire pressure deviation data with deviation threshold data to determine whether the tire pressure deviation exceeds at least one predetermined deviation-related threshold, preferably further comprising correcting the deviation threshold data on the basis of the temperature compensation data; and/or
further comprising controlling at least one of
determining the tire pressure indicating data;
determining the tire pressure deviation data;
obtaining the at least one vehicle data; and
determining the temperature compensation data;
on the basis of the temperature compensation data such that a temperature compensation is achieved;
and/or
being stored on a computer-readable storage medium or in a computer-readable storage device.
